(19) United States
(12) Patent Application Publication
(10) Pub. No.: US 2007/0034698 A1
(43) Pub. Date: Feb. 15, 2007

(54) Card holding device

(75) Inventors: Heinz-Josef Hautvast, Brigachtal (DE); Thomas Riestar, Villingen-Schwenningen (DE); Torsten Wahler, Bad Duerrheim (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/554,057

(22) PCT Filed: Mar. 23, 2004
(86) PCT No.: PCT/EP04/03081

§ 371 Date: Oct. 2, 2006

(30) Foreign Application Priority Data
May 12, 2003 (DE) 103 21 252.3

(51) Int. Cl. G06K 7/00; G06K 13/00

(52) U.S. Cl. 235/486; 235/475

(57) ABSTRACT

The invention relates to a card holding device (1) comprising a guide (42a, 42b) and a clamping unit (3) that clamps a card (5) in a guided manner. Sometimes the frictional connection is not established in the event of an unfavorable use of the device. The aim of the inventive device and method is to reliably draw in and transport cards even in the event of an inappropriate operation of the device and unfavorable constraints. To this end, the clamping unit (3) comprises at least one first resilient element (8) having (9) by means of the guide (42a, 42b) and indirectly or directly clamps the card (5) by means of the at least one second area (10).

The invention relates to a card holding device having at least one guide and having a clamping unit with at least one first clamping element, which clamping unit clamps a card, which is to be held and has two mutually opposite flat faces, on one flat face in a manner controlled by the at least one guide when the clamping unit moves in relation to the at least one guide. A method for holding a card in a card holding device, in particular in a card holding device according to the invention, is also a subject of the invention.

The main focus of application of the device according to the invention and of the method is in the area of tachographs or devices for recording the operating periods and rest periods of commercial vehicle drivers. However, other applications are also feasible, for example in the area of banking and for making payments, or in locking systems. The invention is advantageously used in combination with all types of card-like data storage media. On account of the great economic and legal importance of the data which can be acquired with tachographs, the recordings have to be reliably secured against manipulation. The security measures relate both to data acquisition and data transmission and to the transmission and storage of the acquired data in the memory of the card. Relevant standards place strict requirements on the security standard to be achieved by the measures. It is therefore stipulated that the card be entirely held by the card holding device during the reading and writing operations and be isolated from the surroundings by means of suitable closure devices. The closure devices have to be locked in the closed position during the reading and writing operations. Additional difficulties arise, particularly in the case of tachographs, on account of operational failures in conventional devices caused by contamination, in particular by contact being interrupted or even when the card is being drawn in. It is problematical to draw in the card and position it exactly on the contacts of the device because the various cards have high manufacturing tolerances in relation to the required positional accuracy with respect to the contacts of the device. Since the cards are predominantly perceived by the user to be distinguished by a high degree of robustness, said cards are generally not handled with the care that is actually required, so that, in addition to the tolerances caused by manufacture, deformation and damage impair the way in which the card operates when interacting with the card holding devices. Furthermore, the operating conditions in motor vehicles place increased requirements on functional reliability on account of the pronounced vibrations and countless bumps and the wide-ranging temperature fluctuations. Implementing security against manipulation and the desired handling convenience mean it is necessary to draw in the card fully automatically. However, in order to meet this requirement, great difficulties are faced in terms of construction because the installation space available in a tachograph which is the size of a car radio provides only approximately a height of 10 mm for the fully automatic drawing-in process.

DP 102 08 259.6 has already disclosed a smart-card holding device of fully automatic design, in which two clamping elements are spring-mounted on a slide, grasp the inserted smart card in the manner of tongs and transport it into a read/write position.

However, it has been found that the approach of grasping the smart card by means of two clamping elements, which approach is correct in principle, creates additional problems. Depending on the deformation of the card which is inserted and as a function of the strength of the card in the tolerance range, the force fit which is produced between the card and the clamping elements is not good enough to cope with unfavorable operation of the apparatus, for example by the card being held tightly.

On the basis of the problems and disadvantages of the prior art, the invention has set itself the object of providing a card holding device and a method for holding a card, which device is able to reliably draw in a card under the unfavorable boundary conditions described above, even when the apparatus is operated in an unsuitable manner, and to transport the card to the end position for the read/write operation.

According to the invention, the object is achieved by a card holding device of the type mentioned in the introduction, in which the clamping unit has at least one elastic element which is guided indirectly or directly at at least one first region by means of the at least one guide, or clamps indirectly or directly by means of at least one second region.

The inventive use of an elastic element in the clamping unit of a card holding device allows conflicting aims to be realized, specifically those of tightly clamping the card, which is to be held, in a secure manner and transporting said card when there are high degrees of deformation and contamination, due to a relatively high clamping force and at the same time maximum tolerance with respect to faulty operation. In contrast to the transporting systems comprising rubber rollers which have been customary to date and have always needed a great deal of installation space since the rubber rollers require a certain minimum diameter in order to operate reliably, an extremely flat structural shape can be realized according to the invention. The arrangement according to the invention also enables the card, which is to be held, to be drawn as far into the device as desired without having to arrange a plurality of rollers in series, as is the case for transportation using rubber rollers. Controlling the clamping force produced by the elastic element by means of the guide makes it possible to vary the clamping force on the smart card in accordance with requirements, for example a maximum contact pressure force may be provided while the card is still accessible from the outside, and the clamping force may then be reduced in the apparatus.

One advantageous development of the invention provides for the elastic element to be part of a first clamping element and to be guided with a first region by means of the at least one guide and, by interacting with the second clamping element, to clamp the card by means of a second region. This arrangement expediently combines the function of the elastic element with the function of a clamping element, so that the design of the device is less complicated, the number of components is reduced, the outlay on installation is reduced, and susceptibility to faults decreases.

In addition, the overall height of the device in particular can be reduced since the elastic element and that clamping element which is combined with the elastic element are otherwise located in the vertical direction next to the card, which is to be held, or the card shaft.

Improved precision of the force fit is achieved when the clamping unit has at least one second clamping element, the second region of the elastic element touches the first clamping element and, during the clamping process, presses against the card in such a way that the first clamping element and the second clamping element clamp a card, which is to be held, on the two opposite flat faces. Since the function of the elastic element is separated from that of the clamping element in this embodiment, the two components can be matched to their tasks more effectively and the drawing-in process can be realized even more precisely.

The movement of the clamping unit can expediently also be used for the inventive clamping action when the clamping unit clamps the card in a manner controlled by the guide when the clamping unit moves in an inward direction of the card holding device. In this way, it is advantageously possible for an individual drive for transporting the clamping unit in the inward direction to also drive the clamping action of the card in the clamping unit.

Very flat structural shapes and high clamping forces can be realized when the elastic element is in the form of a leaf spring. It is also feasible to use a bar spring or leg spring. In this context, one advantageous development provides for one end of the leaf spring to be rotatably mounted in a rotation axis, the first region, at which the leaf spring is guided by means of the guide, to be arranged at the opposite end, and the second region to be arranged close to the rotation axis. In this case, the rotation axis does not have to be spatially fixed when rotating through an angle of rotation which is generally only small. This is predominantly the case when the leaf spring in the region is not mounted so as to rotate in a specific shaft but, in a simplified fashion, is held down there only in the direction of the card. Increasing the clamping forces achieved by means of a leaf spring leads to increased frictional forces of the elastic element or of the leaf spring in the guide which controls the prestressing force, and to an increased drive capacity required for the drawing-in movement of the clamping unit. In order to avoid this, the invention provides for the leaf spring to have, in the second region, a bend which faces the card and runs in the direction of the bending moment on the leaf spring. The bend is in direct contact with the second clamping unit or in indirect contact with the card which is to be clamped. The distance between the bend in the leaf spring and the guided first region of the leaf spring acts as a lever which reduces the bearing force in the guide. As an alternative solution to the bend in the leaf spring, an embossed section can be produced at the top of the clamping part. This embossed section serves as a bearing face for the leaf spring.

The moving parts of the device are positioned securely when at least one clamping element can be lowered onto the card, which is to be held, in a substantially rotatory manner, and the card can be clamped in this way. In this context, it is expedient when the card, which is to be held, is clamped in the manner of tongs by means of the clamping elements. The invention advantageously makes use of the lever ratios of the tong-like clamping system in this way.

In order to achieve particularly uniform loading on the card and homogeneous wear over the entire flat face of the card, it is expedient when a clamping element can be lowered onto the card, which is to be held, in a substantially translatory manner, and the card can be clamped in this way. Lowering the clamping element in a translatory manner also has the advantage that the card does not have a preferred direction of deflection during the clamping process.

In a further refinement of the invention, it is expedient when the card holding device has two guide elements which are located at the side of a card holding shaft, the elastic element, for example a leaf spring, extends substantially over the width of the card holding shaft, the elastic element has at least two first regions, and the elastic element is respectively guided with a respective first region on the guide which is arranged at the side. This largely symmetrical design ensures that force is always introduced into the card in a uniform manner.

In order to achieve maximum tolerance with respect to faulty operation, it is expedient when the guide is formed in such a way that the clamping force on the card initially increases when said card moves in the inward direction. The increase in the clamping force should have as steep a characteristic curve as possible, so that the slip of the card in the clamping unit is reduced to a minimum length. The card should be drawn in by means of an electric motor drive which drives the clamping unit together with the card in the inward direction of the holding device. On account of the guides according to the invention, only one electric drive expediently needs to be provided since the clamping process is coupled to the inward movement of the clamping unit in a mechanically advantageous manner. It is possible to completely draw a card into a card holding device on such a flat installation space in a fully automatic manner, which is secure against manipulation, only on account of the inventive clamping action.

The required security against manipulation can be ensured when the card holding device has an insertion opening with a closure element, and the insertion opening can be closed by means of the closure element. The legal regulations for preventing manipulation are satisfied when a locking unit locks the closure element in a closed position.

In order to prevent destruction of the drive, in particular as a result of gross faulty operation, it is expedient when a slip clutch is arranged between the drive and the clamping unit.

In order to prevent the device from being damaged on account of highly careless insertion of a card, it is advantageous when a second elastic element is arranged between the drive for the inward movement of the clamping unit and the clamping unit, this elastic element resiliently absorbing inward movements of the clamping unit on account of a force introduced into the clamping unit from the outside by means of a card. This means that the abovementioned slip clutch which is relatively expensive may be dispensed with, if desired.

The reliability of the clamping action is increased when the clamping unit is at least partly provided with friction linings in regions which touch and clamp the card. As an alternative, it is expedient to roughen the clamping faces in order to thus increase the coefficient of friction and therefore the frictional force between the card and the clamping unit.

In order to achieve the object of the invention, a method for holding a card in a card holding device is also proposed in addition to the card holding device, in which method, during a first period of movement, the card is first of all manually inserted through an insertion opening and at a first end position reaches a stop of a clamping unit, during a second period of movement the clamping unit is manually pushed in the inward direction by means of the card and the guide presses a second region of an elastic element, which is guided indirectly or directly by means of the guide at a first region, indirectly or directly against the card, and a sensor registers the end of the second period of movement, and at the beginning of a third period of movement the sensor initiates activation of a drive which transports the clamping unit in an inward direction. It is expedient here for a second elastic element to prestress the clamping unit against manual pushing in the inward direction, so that the user senses an increasing resistance before the card is drawn in fully automatically. The advantage of this procedure can be seen firstly in the improved ergonomics and secondly in the card butting securely against the rear stop of the clamping unit, so that only small corrections to the card positions are necessary in order to ensure that contact is reliably made in the end position. The fact that the end face of the card bears against the stop of the clamping unit at the insertion end is particularly important because the position of the contact group of the card is tolerated by this edge.

Operation is made somewhat more convenient for a user when during a first period of movement the card is first of all manually inserted into an insertion opening and registered by a sensor at a first end position, at the beginning of a second period of movement the sensor initiates activation of a drive which transports the clamping unit in an inward direction while the guide presses a second region of an elastic element, which is guided indirectly or directly by means of the guide at a first region, indirectly or directly against the card. If, in this drawing-in process, the card does not bear completely against corresponding stops of the clamping unit, the position of the card can be corrected by means of subsequent operations in the device. This may be performed, for example, by means of a locking system which extends laterally in the insertion plane into the insertion opening at the input end and preferably resiliently touches the card and pushes it into an end position, with the clamping action expediently being released in advance so that the card can be pressed against corresponding stops.

In order to achieve the object, a method of the above type is also proposed in which during a first period of movement the card is first of all manually inserted into an insertion opening and registered by a sensor at a first end position, a guide can be moved in an inward direction and the sensor initiates activation of a drive which moves the guide in the inward direction, and a clamping arrangement clamps the card by the guide pressing a second region of an elastic element, which is indirectly or directly guided at a first region by means of the guide, indirectly or directly against the card, and during a third period of movement the clamping unit transports the card in the inward direction.

Particularly reliable contact is made with the card for the purpose of data transmission when during a fourth period of movement the clamping action is released from the card for the purpose of finely positioning the card, and the card is finely positioned in relation to a contact set, so that a subsequent data transmission phase is conducted without any errors. To this end, the card may advantageously be transported to the end position, preferably at a stop provided in the end position at the housing end, by means of a fine-positioning element after the separation is released. In a further refinement, a fine-positioning element has proven expedient here which presses the card against a housing-end stop, which is in the end position, in the inward direction at the input-end end face or at the corners or rounded sections adjoining the input-end edge of the card. The function of the fine-positioning element can expediently be combined with that of a locking unit which preferably has two locking elements which extend into the holding opening in the device from both sides, touch the card, which is already in the housing, at the two input-end corners, and press or transport said card into the end position.

For reasons of clarification, the invention is described in greater detail below with reference to drawings, in which:

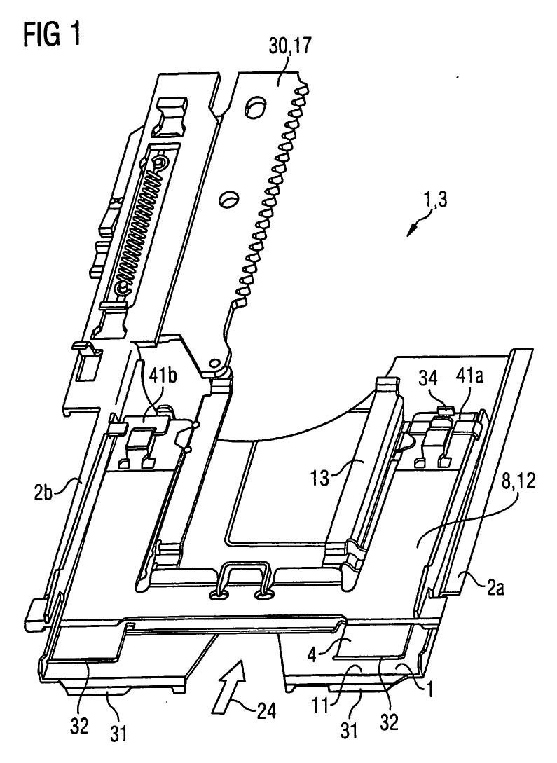

FIG. 1 shows a perspective illustration of a clamping unit,

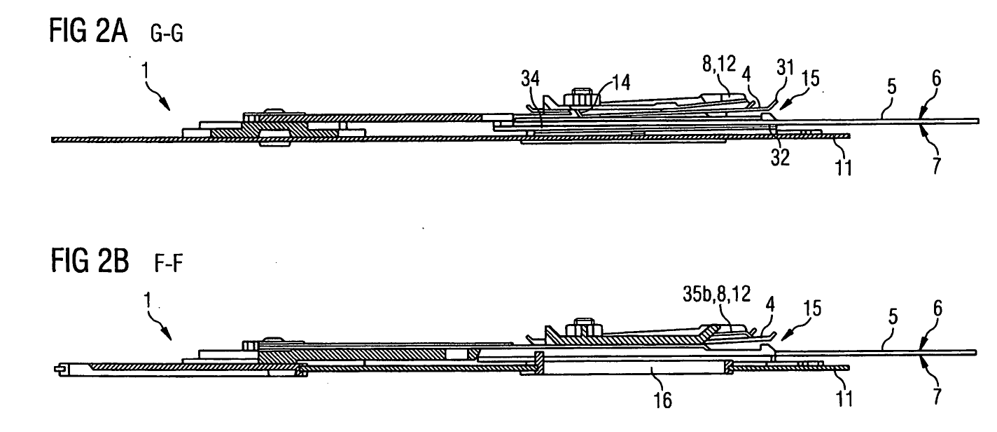

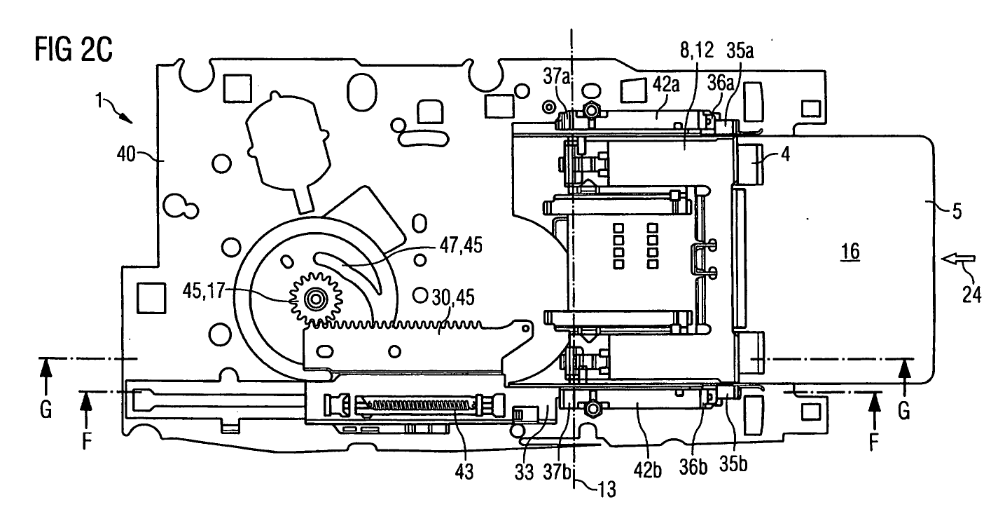

FIGS. 2a, 2b, 3a, 3b, 4a, 4b, 5a, 5b each show a longitudinal section through a clamping unit according to the invention, with adjacent subassemblies in different holding phases for the card, in each case in accordance with the sections G-G and, respectively, F-F illustrated in FIGS. 2c, 3c, 4c, 5c, and

FIGS. 2c, 3c, 4c, 5c each show plan views of a clamping unit according to the invention with adjacent subassemblies.

FIG. 1 illustrates a clamping unit 3 of a card holding device 1 with adjacent subassemblies. The essential constituent parts are lateral supports 2a, 2b, a first clamping element 4 and a second clamping element 11, which surround a card holding shaft 15 arranged in an insertion plane 16, a first elastic element 8 or leaf spring 12, and a toothed rack 30 of a drive.

As is also shown in the illustrations of the following figures, the clamping unit 3 can be linearly displaced, so as to be mounted in sliding fashion, in an inward direction 24 along guides 42a, 42b arranged at the side of the clamping unit 3 in relation to a base support 40 by means of the supports 2a, 2b.

The clamping unit grasps the inserted card 5 in the manner of tongs by means of the first clamping element 4 bearing against a first flat face 6 of the card 5 and the second clamping element 11 bearing against a second flat face 7 of the card 5.

The first clamping element 4 is attached to the clamping unit 3 such that it is rotatably mounted in a rotation axis 13. This attachment essentially involves holding down by means of two holding-down means 41a, 41b which are stationary constituent parts of the clamping unit 3. The first elastic element 8, or the leaf spring 12, which is fixed to the clamping unit 3 in the same way by means of the holding-down means 41a, 41b, is also rotatably mounted in the rotation axis 13.

The leaf spring 12 has a first region 9 which is arranged at the input end in the inward direction 24, and a second region 10 which is arranged at the end in the inward direction 24. In the first region 9, the leaf spring 12 has guide elements 35a, 35b which protrude in the manner of wings on both sides of the insertion region for the card 5. The first region 9 is guided in the guides 42a, 42b by means of the guide elements 35a, 35b in such a way that a movement of the leaf spring 12 in relation to the guides 42a, 42b in the inward direction 24 leads to the first region 9 being moved in guided fashion in the direction of the spacing from the card 5 which is to be held. The guides 42a, 42b therefore have a double function: they perform the translatory movement of the clamping unit 3 in the inward direction 24 and the clamping movement of the first clamping element 4 or the leaf spring 12 which takes place in the direction of the spacing from the card 5 and perpendicular to the insertion plane 16. In the second region 10, the leaf spring 12 is rotatably mounted in the rotary shaft 13. In the second region 10, the leaf spring 12 is provided with a bend 14 which runs in the direction of the card 5, which is to be held, and of the second clamping element 11 and which presses on the second clamping element 11 with the pressure of the guides 42a, 42b on the leaf spring 12, the clamping element 11 bearing against a first flat face 6 of the card 5 and clamping said card in place by interacting with the first clamping element 4.

The second clamping element 11 of the clamping unit 3 is integrally formed with the lateral supports 2a, 2b, with the result that the second clamping element 11 executes a pure translatory movement along the lateral guides 42a, 42b within the context of the drawing-in movement.

The second clamping element 11 is provided with insertion slopes 31 at the input end, so that even a card 5 which has not been precisely inserted passes between the first clamping element 4 and the second clamping element 11. The first clamping element 4 is also provided with insertion slopes 32.

In an extended section in the inward direction 24, the first clamping element 4 has a projection 33 on which the toothed rack 30 is linearly mounted in a resilient manner by means of a second elastic element 43. The spring path of the second elastic element 43 allows the clamping unit 3 to yield in the inward direction 24 when a card 5 is pushed against a stop 34 which is arranged at the end in the clamping unit 3.

FIGS. 2a to 5c illustrate the clamping unit 3 of the card holding device 1 with adjacent subassemblies in various phases of the inward movement of the card 5.

The clamping unit 3 and the adjacent subassemblies are fitted on the base plate 40 on which various holding elements for individual components are injection-molded using the outsert technique. Guide elements 16a, 16b for moving the clamping unit 3 so that they are mounted in sliding fashion and are guided on the base support 40 are particularly attached to the base support 40 using the outsert technique.

FIGS. 2a, 2b, 2c show the arrangement with a card 5 inserted up to a stop 34 which is located at the end in the inward direction 24. The leaf spring 12, which is provided with guide wings 35a, 35b in the inward direction 24 at the input end on both sides in a first region 9, is not subject to any bending loads in this movement phase. The guides 42a, 42b are each provided with a run-in slope 36a, 36b and a run-out slope 37a, 37b for the guide elements 35a, 35b of the leaf spring 12. The guide elements 35a, 35b of the leaf spring 12 touch the run-in slopes 36a, 36b. A gear mechanism 45 comprises, amongst other things, the toothed rack 30, a drive gear wheel 17, a guide link 47 and further gear-system components.

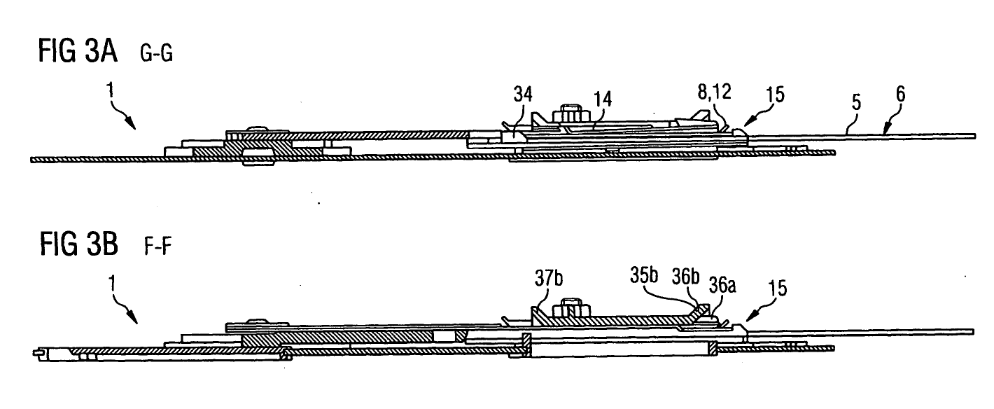

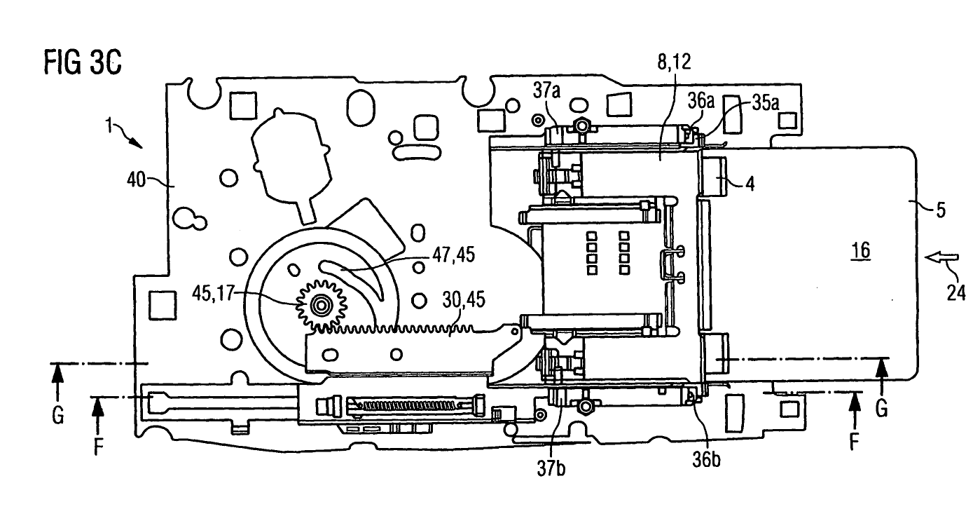

In the movement phase illustrated in FIGS. 3a, 3b, 3c, the clamping unit 3 is manually displaced in the inward direction 24 by means of the card 5. In this case, the guide elements 35a, 35b arranged on both sides of the leaf spring 12 move along the run-in slopes 36a, 36b beneath the guide 42a, 42b, so that the leaf spring 12 is pressed in the direction of the spacing from the inserted card 5. The bend 14 presses the first clamping element 4 onto the card 5. The card is manually pushed further against the resistance, which the user can sense, of the second elastic element 43 which prevents the connected gear-system components from being damaged.

After the card 5 is inserted and clamped, a sensor (not illustrated) registers the presence of the card 5 and a drive (not illustrated) begins to draw in the clamping unit 3 in the inward direction 24 by means of the gear mechanism 45.

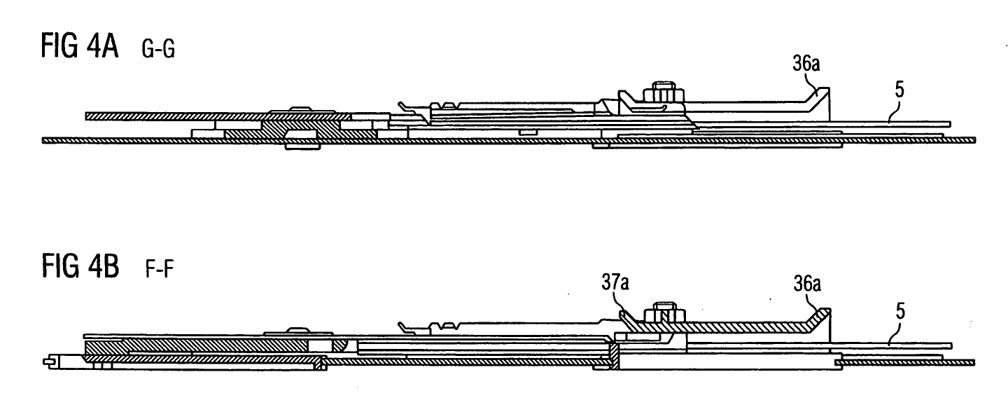

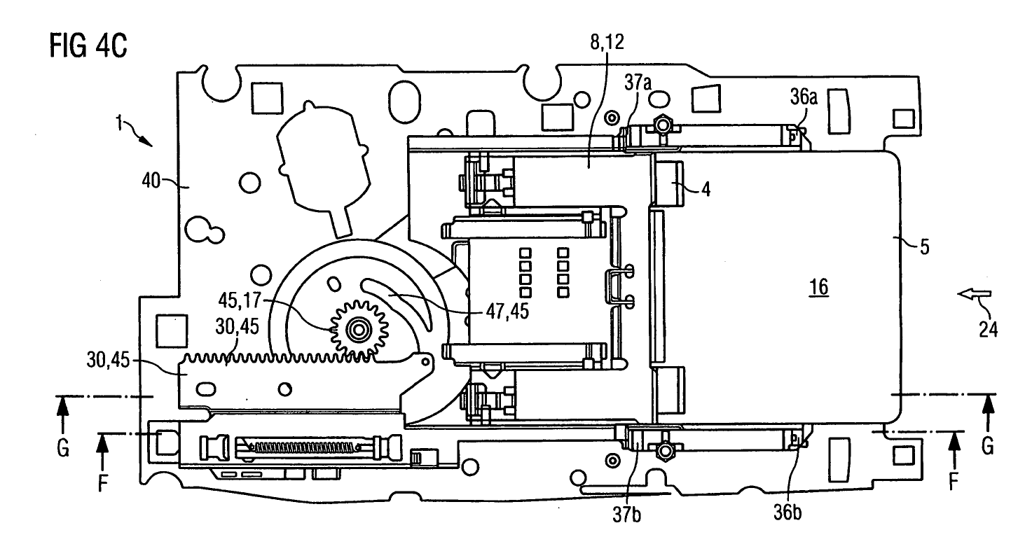

In the movement phase illustrated in FIGS. 4a, 4b, 4c, the drawing-in process of the card 5 is almost complete. The clamping action on the card 5 is just about to be released.

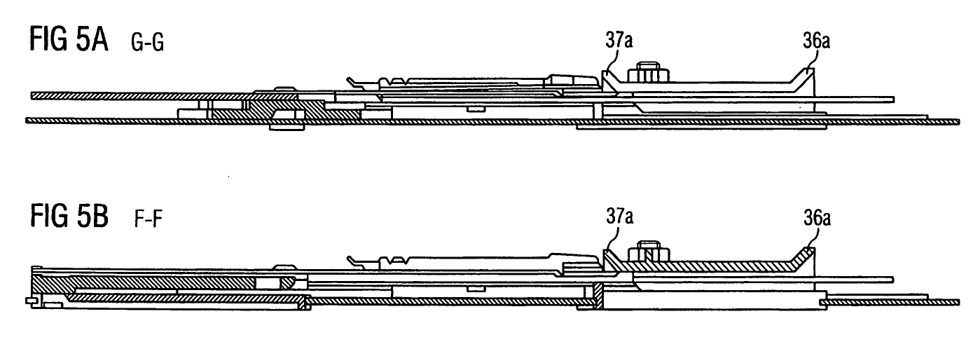

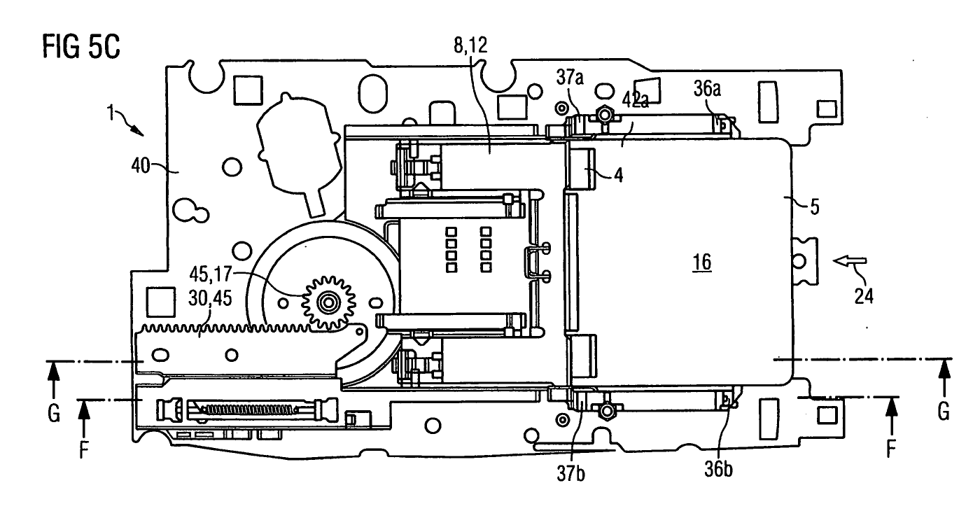

In the movement phase illustrated in FIGS. 5a, 5b, 5c, the card 5 is completely drawn into the device and the guide elements 35a, 35b of the leaf spring 12 each run along one run-out slope 37a, 37b, with the result that the clamping action on the card 5 is released by means of the leaf spring 12 and the second clamping element 11. In a subsequent working step (not described), the card 5 can be finely positioned in the device by means of suitable thrust elements.

1. (cancelled).

2. (cancelled).

3. (cancelled).

4. (cancelled).

5. (cancelled).

6. (cancelled).

7. (cancelled).

8. (cancelled).

9. (cancelled).

10. (cancelled).

11. (cancelled).

12. (cancelled).

13. (cancelled).

14. (cancelled).

15. (cancelled).

16. (cancelled).

17. (cancelled).

18. (cancelled).

19. (cancelled).

20. (cancelled).

21. (cancelled).

22. (cancelled).

23. (cancelled).

24. (cancelled).

25. A card holding device, comprising:
at least one guide;
a clamping unit comprising:
at least one first clamping element arranged to clamp a card which is to be held;
at least one first elastic element comprising a first and second region;
two mutually opposite flat faces arranged such that on one flat face, in a manner controlled by the at least one guide, when the clamping unit moves in relation to the at least one guide, the at least one first elastic element is guided indirectly or directly at the at least first region by means of the at least one guide, and clamps the card indirectly or directly by means of the at least one second region,
an electric motor drive arranged such that the inward movement of the card can be driven at least partly by means of the drive, and wherein
at least one clamping element is rotatably mounted about a rotation axis, and the card, which is to be held, can be clamped in the manner of tongs by means of the clamping elements.

26. The card holding device according to claim 25, wherein the first elastic element is part of the first clamping element and is arranged to be guided with a first region by means of the at least one guide and, by interacting with the first clamping element, clamps the card by means of a second region.

27. The card holding device according to claim 25, wherein the clamping unit has at least one second clamping element, the second region of the elastic element is arranged to touch the first clamping element and, during the clamping process, presses against the card in such a way that the first clamping element and the second clamping element clamp a card, which is to be held, on the two opposite flat faces.

28. The card holding device according to claim 25, wherein the clamping unit is arranged to clamp the card in a manner controlled by the at least one guide when the clamping unit moves in an inward direction with respect to the card holding device.

29. The card holding device according to claim 25, wherein the elastic element is a leaf spring.

30. The card holding device according to claim 29, wherein:
one end of the leaf spring is rotatably mounted in a rotation axis,
the first region, at which the leaf spring is guided by means of the at least one guide, is arranged at the opposite end, and
the second region is arranged close to the rotation axis.

31. The card holding device according to claim 30, wherein the leaf spring comprises, in the second region, a bend which faces the card and runs in a direction of the bending moment on the leaf spring.

32. The card holding device according to claim 25, wherein the at least one clamping element is arranged to be lowered onto the card, which is to be held, in a substantially rotatory manner, so as to clamp the card.

33. The card holding device according to claim 25, wherein the at least one clamping element is arranged to be lowered onto the card, which is to be held, in a substantially translatory manner, so as to clamp the card.

34. The card holding device according to claim 25, wherein the card holding device has two guides which are located at the side of a card holding shaft, the elastic element extends substantially over the width of the card holding shaft, the elastic element has at least two guide elements which are arranged at the side in the first region, and the elastic element is respectively guided by means of a respective guide element on the guides which are arranged at the side.

35. The card holding device according to claim 25, wherein the guide is formed such that the clamping force on the card initially increases when the card moves in the inward direction.

36. The card holding device according to claim 25, wherein the card can be completely drawn into the card holding device.

37. The card holding device according to claim 36, wherein the card holding device comprises an insertion opening and a closure element and the insertion opening is arranged to be closed by means of the closure element.

38. The card holding device according to claim 37, wherein the card holding device has at least one locking unit, and the closure element can be locked in a closed position by means of a locking unit.

39. The card holding device according to claim 25, further comprising a slip clutch arranged between the drive and the clamping unit.

40. The card holding device according to claim 25, wherein the clamping unit is at least partly provided with friction linings in regions which touch and clamp the card.

41. A method for holding a card in a card holding device, comprising the steps of:
inserting the card through an insertion opening, during a first period of movement,
pushing the clamping unit in a inward direction, as a first end position reaches a stop of a clamping unit, during a second period of movement, by means of the card and a guide arranged to press a second region of an elastic element which is guided indirectly or directly by means of the guide at a first region indirectly or directly against the card,
sensing an end of the second period of movement with a sensor, and
initiating activation of a drive, with the sensor, at the beginning of a third period of movement, the drive arranged to transport the clamping unit in an inward direction.

42. The method according to claim 41, wherein:
during the first period the card is initially manually inserted into an insertion opening and registered by a sensor at a first end position, and
at the beginning of a second period of movement the sensor initiates activation of a drive which transports the clamping unit in an inward direction while a guide presses a second region of an elastic element, which is guided indirectly or directly by means of the guide at a first region, indirectly or directly against the card.

43. The method according to claim 41, wherein:
during the first period the card is initially manually inserted into an insertion opening and registered by a sensor at a first end position, a guide can be moved in an inward direction and the sensor initiates activation of a drive which moves the guide in the inward direction, and a clamping unit clamps the card by the guide pressing a second region of an elastic element, which is indirectly or directly guided at a first region by means of the guide, indirectly or directly against the card, and
during a third period of movement the clamping unit transports the card in the inward direction.

44. The method according to claim 43, wherein during a fourth period of movement the clamping action on the card is released and the card is finely positioned in relation to a contact set.

45. The method as claimed in claim 44, wherein the card is pressed in the inward direction against a housing-end stop of the end position by means of a fine-positioning element after the clamping action on the input-end end face or on the input-end corners of the card is released.
